(19) United States
(12) Patent Application Publication
(10) Pub. No.: US 2014/0133767 A1
(43) Pub. Date: May 15, 2014

(54) SCANNED TEXT WORD RECOGNITION METHOD AND APPARATUS

(71) Applicant: Brigham Young University, Provo, UT (US)

(72) Inventors: William B. Lund, Provo, UT (US); Eric K. Ringger, Provo, UT (US)

(73) Assignee: Brigham Young University, Provo, UT (US)

(21) Appl. No.: 14/075,187

(22) Filed: Nov. 8, 2013

Related U.S. Application Data
(60) Provisional application No. 61/724,649, filed on Nov. 9, 2012.

(51) Int. Cl. G06K 9/00

(52) U.S. Cl. CPC G06K 9/00456
USPC 382/229

(57) ABSTRACT

A method for converting digital images to words includes receiving a digital image comprising text, generating a binary image from the digital image for each of N binarization threshold values to provide N binary images, converting each of the N binary images to text, and aligning the text from the N binary images to provide a word lattice for the digital image. Aligning the text may include prioritizing the text from the N binary images according to error rates on a training set. The training set may be a synthetic training set. An apparatus corresponding to the above method is also disclosed herein.

### RELATED APPLICATIONS

This application claims the benefit of U.S. Provisional Application 61/724,649 entitled “Combining Multiple Thresholding Binarization Values to Improve OCR Output” and filed on 9 Nov. 2012 for William B. Lund and Eric K. Ringger. The aforementioned application is incorporated herein by reference.

### BACKGROUND OF THE INVENTION

1. Field of the Invention

The subject matter disclosed herein relates to recognizing word sequences within digital images of text.

2. Description of the Related Art

Printing and duplication techniques of the 19th and mid-20th centuries create significant problems for OCR engines. Examples of problematic documents include typewritten text, in which letters are partially formed, typed over, or overlapping; documents duplicated by mimeographing, carbon paper, or multiple iterations of photographic copying common in the mid-20th century; and newsprint which uses papers that are acidic and type that can exhibit incomplete characters. In addition to original documents which may exhibit problematic text, newspapers may suffer degradation such as bleed-through of type and images, damage due to water, and discoloring of the paper itself.

Extracting usable text from older, degraded documents is often unreliable, frequently to the point of being unusable. Even in situations where a fairly low character error rate is achieved, Hull [Hull, J., “Incorporating language syntax in visual text recognition with a statistical model,” Pattern Analysis and Machine Intelligence, IEEE Transactions on 18(12), 1251-1255 (1996)] points out that a 1.4% character error rate results in a 7% word error rate on a typical page of 2,500 characters and 500 words (see FIG. 1).

Image binarization methods create bitonal (black and white) versions of images in which black pixels are considered to be the foreground (characters or ink) and white pixels are the document background. The simplest form of binarization is global thresholding, in which a grayscale intensity threshold is selected and then each pixel is set to either black or white depending on whether it is darker or lighter than the threshold, respectively.

Since the brightness and contrast of document images can vary widely, it is often not possible to select a single threshold that is suitable for an entire collection of images. Referring to FIG. 2, the Otsu method [Otsu, N., “A threshold selection method from gray-level histograms,” IEEE Transactions of Systems, Man, and Cybernetics SMC-9, 62-66 (January 1979)] is commonly used to automatically determine thresholds on a per-image basis. The method assumes two classes of pixels (foreground and background) and uses the histogram of grayscale values in the image to choose the threshold that maximizes between-class variance and minimizes within-class variance. This statistically optimal solution may or may not be the best threshold for OCR, but often works well for clean documents.

For some images, no global (image-wide) threshold exists that results in good binarization. Background noise, stray marks, or ink bleed-through from the back side of a page may be darker than some of the desired text. Stains, uneven brightness, paper degradation, or faded print can mean that some parts of the page are too light for a given threshold while other parts are too dark for the same threshold.

Adaptive thresholding methods attempt to compensate for inconsistent brightness and contrast in images by selecting a threshold for each pixel based on the properties of a small portion of the image (window) surrounding that pixel, instead of the whole image. Referring again to FIG. 2, the Sauvola method [Sauvola, J. and Pietik\ddot{}ainen, M., “Adaptive document image binarization,” Pattern Recognition 33(2), 225-236 (2000)] is a well-known adaptive thresholding method. Sauvola performs better than the Otsu method in some cases; however, neither is better in all cases, and in some cases adaptive thresholding methods even accentuate noise more than global thresholding. In addition, the results of the Sauvola method on any given document are dependent on user-tunable parameters. Similar to global thresholds, a specific parameter setting may not be sufficient for good results across an entire set of documents.

Although the Otsu and Sauvola methods are well known and widely-used binarization methods, a large body of research exists for binarization in general and also specifically for binarization of document images. While various methods perform well in many situations, recognition robustness for degraded documents remains an issue.

Given the foregoing, what is needed are systems, apparatuses and methods for robust recognition of word sequences within digital images of text for a wide variety of degraded documents without requiring parameter tuning.

### BRIEF SUMMARY OF THE INVENTION

The present invention has been developed in response to the present state of the art, and in particular, in response to the problems and needs in the art that have not yet been fully solved by currently available optical character recognition systems, apparatuses, and methods. Accordingly, the claimed inventions have been developed to provide systems, apparatuses, and methods that overcome shortcomings in the art.

As detailed below, a method for converting digital images to words includes receiving a digital image comprising text, generating a binary image from the digital image for each of N binarization threshold values to provide N binary images, converting each of the N binary images to text, and aligning the text from the N binary images to provide a word lattice for the digital image. Aligning the text may include prioritizing the text from the N binary images according to error rates on a training set. The training set may be a synthetic training set.

An apparatus corresponding to the above method is also disclosed herein. It should be noted that references throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a graph depicting the relationship between word error rates and character error rates;

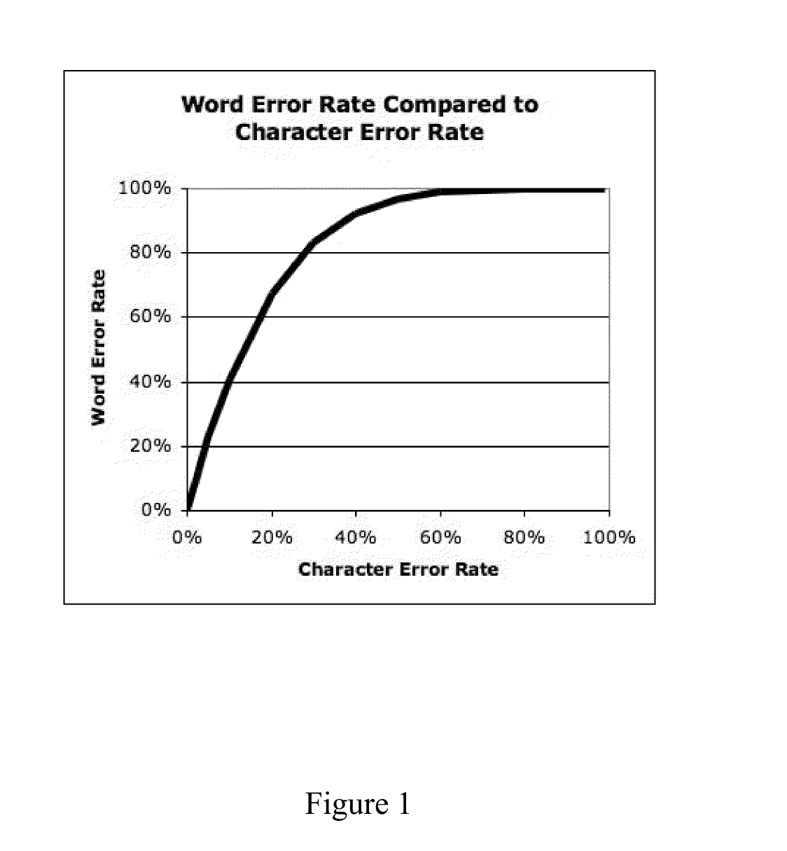

FIG. 2 is a set of images that depict the effect of adaptive binarization on a digital image containing text;

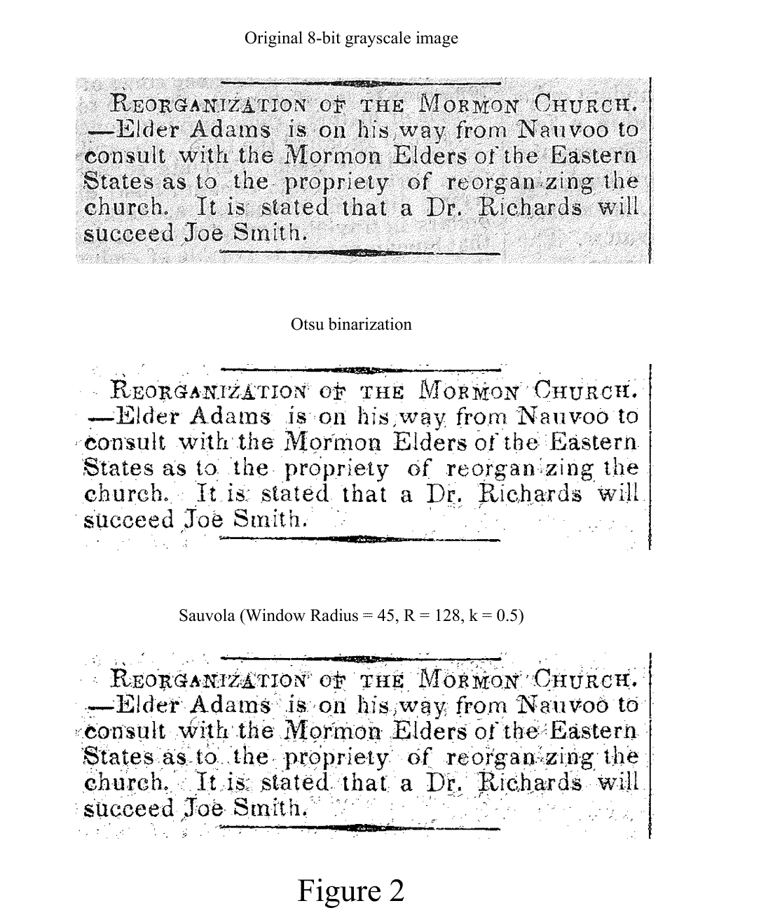

FIG. 3 is a set of images that depict the effect of multiple-threshold-level binarization on a digital image containing text;

FIG. 4 is a block diagram of a word recognition apparatus that leverages multiple-threshold-level binarization;

FIG. 5 is a flowchart diagram of a word recognition method that leverages multiple-threshold-level binarization;

FIG. 6 is an example digital image containing text and a corresponding word lattice generated therefrom using one embodiment of the method of FIG. 4; and

FIGS. 7a and 7c are tables and FIGS. 7b and 7d are graphs comparing word error rates for optical character recognition using grayscale images for a specific corpus along with various forms of binarization on the grayscale images.

### DETAILED DESCRIPTION OF THE INVENTION

Many of the functional units described in this specification have been labeled as modules, in order to more particularly emphasize their implementation independence. Others are assumed to be modules. For example, a module or similar unit of functionality may be implemented as a hardware circuit comprising custom VLSI circuits or gate arrays, off-the-shelf semiconductors such as logic chips, transistors, or other discrete components. A module may also be implemented with programmable hardware devices such as field programmable gate arrays, programmable array logic, programmable logic devices or the like.

A module or a set of modules may also be implemented (in whole or in part) as a processor configured with software to perform the specified functionality. An identified module may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. For example, a module may be implemented as an on-demand service that is partitioned onto, or replicated on, one or more servers.

Indeed, the executable code of a module may be a single instruction, or many instructions, and may even be distributed over several different code segments, among different programs, and across several memory and processing devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any tangible form capable of enabling execution of a program of machine-readable instructions on a digital processing apparatus. For example, a computer readable medium may be embodied by a flash drive, compact disk, digital-video disk, a magnetic tape, a magnetic disk, a punch card, flash memory, integrated circuits, or other digital processing apparatus memory device. A digital processing apparatus such as a computer may store instructions such as program codes, parameters, associated data, and the like on the computer readable medium that when retrieved enable the digital processing apparatus to execute the functionality specified by the modules.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

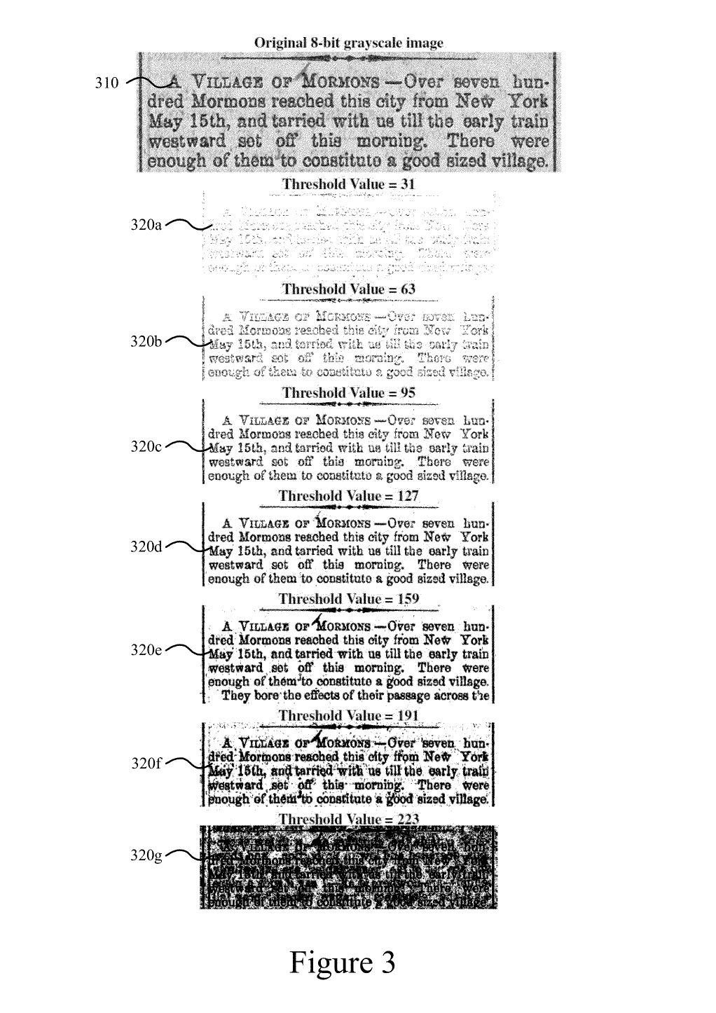

As mentioned above, optimization of binarization thresholds including fixed-level, global, and adaptive optimization may not result in robust optical character recognition—particularly for historical documents. As disclosed herein, a method and apparatus for converting digital images to text eliminates the requirement for optimization of binarization thresholds by generating multiple binary versions of a digital image corresponding to multiple distinct threshold levels. For example, as shown in FIG. 3 a digital image 310 comprising text may undergo binarization to provide N binary images 320 corresponding to N distinct threshold values. In the depicted example, the digital image is an 8-bit greyscale image and seven binary images 320a through 320g corresponding to threshold values ranging from 31 through 223 are generated via binarization. The reader may appreciate that certain regions of text within the digital image 310 may be more clearly represented with different levels of binarization thresholding than others. By leveraging multiple binary images corresponding to multiple threshold levels, optimization or adaptation of the binarization threshold level is not required.

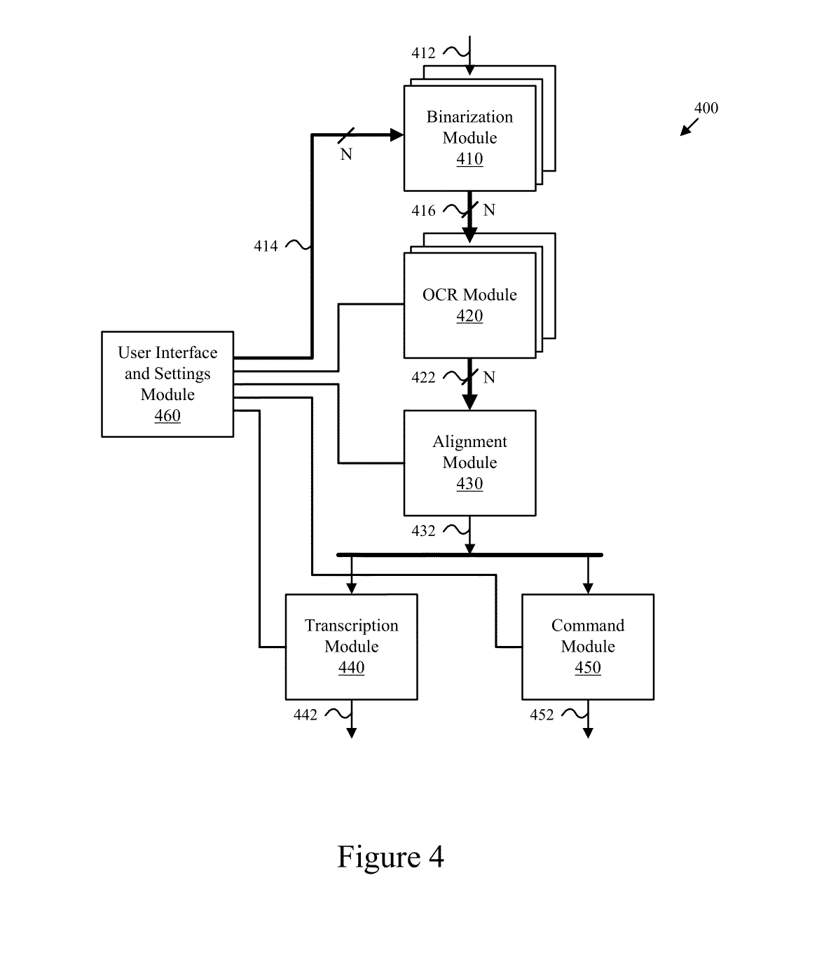

FIG. 4 is a block diagram of a word recognition apparatus 400 that leverages multiple-threshold-level binarization. As depicted, the apparatus 400 may include one or more binarization modules 410, one or more OCR modules 420, an alignment module 430, a transcription module 440, a command module 450, and a user interface and settings module 460. The apparatus 400 may enable robust recognition of word sequences within digital images of text for a wide variety of degraded documents without requiring parameter tuning.

Each binarization module 410 may convert a digital image 412 such as a color image or grayscale image to a binary image 416 according to a distinct threshold value 414. The digital image 412 may include (i.e. capture) images of text. For example, the digital image 412 may be a scanned or photographed document, a scanned or photographed label, or the like.

The OCR modules 420 may convert the N binary images 416 to N text streams 422. The threshold values 414 may, or may not be, equally spaced values. The number of threshold values 414 (i.e., N) may be identical to the number of binary images 416 (i.e., N) generated by the binarization module(s) 410. However, the number of binarization modules 410 and OCR modules 420 may, or may not correspond to the number of threshold values 414 and binary images 416 (i.e., N.) For example, a single binarization module 410 may operate N times on the digital image 412 to provide the N binary images 416.

The alignment module 430 may align the N text streams 422 and provide a word lattice 432. In one embodiment, the alignment module 430 prioritizes the text streams 422 according to error rates on a training set. For example, text streams that have lower error rates may be given higher priority than text streams with higher error rates. The training set may be a synthetic training set with known correct results or a selected portion of a corpus that is annotated with correct results (i.e., ground-truth annotations). For more information on synthetic training sets see “A Synthetic Document Image Dataset for Developing and Evaluating Historical Document Processing Methods” by Daniel Walker, William Lund, and Eric Ringger, DRR 2012

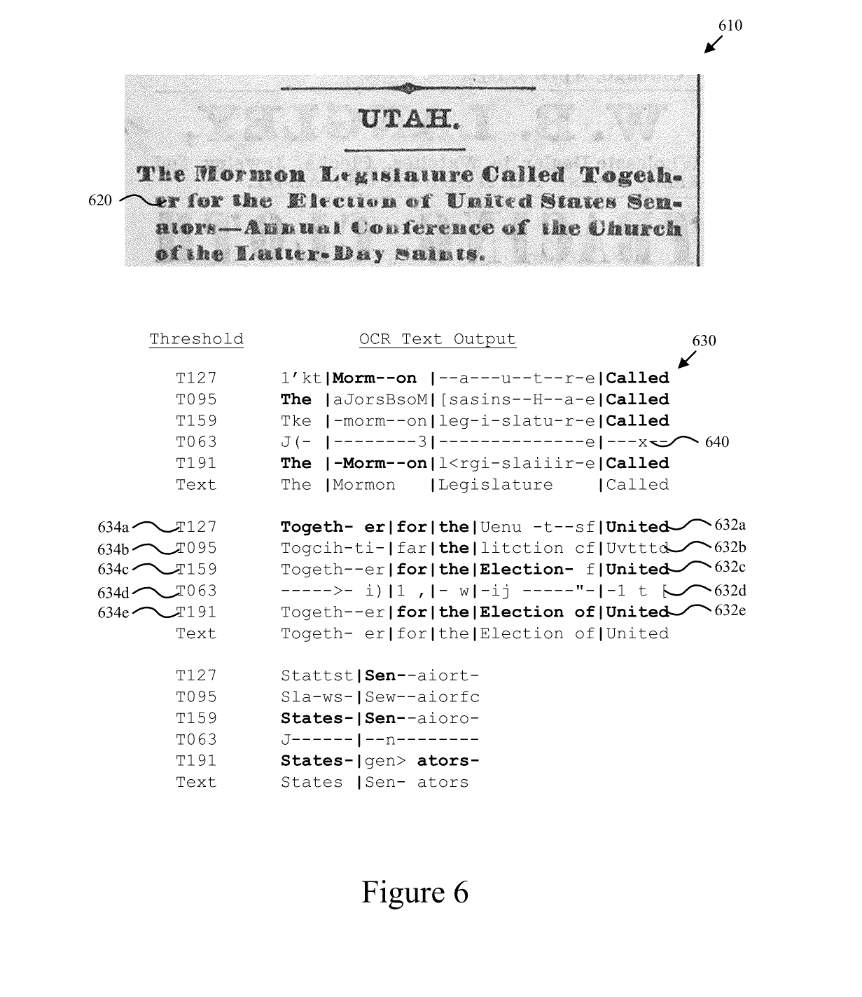

The alignment provided by the alignment module 430 may be computed using progressive alignment or an optimal alignment from all possible combinations. In one embodiment, the alignment module 430 conducts a progressive alignment that includes inserting gaps within one or more higher priority text streams 422 to facilitate the alignment process (see FIG. 6).

The word lattice 432 may be leveraged by the transcription module 440 to provide a word transcription stream 442. For example, the transcription module 440 may select a word transcription from among alternative transcription hypotheses encoded in the word lattice using a selection model. The selection model may be embedded within the transcription module 440 or provided via the user interface and settings module 460. The selection model may leverage a textual context detected within the word transcription stream 442 or specified by the user. The textual context may include a vocabulary collected from the word transcription stream 442 or specified by a user.

The word lattice 432 may also be leveraged by the command module 450 to provide a command stream 452. In some embodiments, the command module 450 also initiates actions corresponding to commands within the command stream 452. Both the word transcription stream 442 and the command stream 452 may be leveraged by one or more applications (not shown) executing on a computing system (not shown).

In certain embodiments, the OCR module 420 may provide multiple characters for each character position in the text stream 422. A character weight or score for each character may also be included in the text stream 422. The alignment module 430 and the transcription module 440 or the command module 450 may use the multiple characters and/or character weights to assist in aligning the text streams and selecting the words provided in the word transcription stream 442 or the command stream 552. In one embodiment, multiple characters are treated as additional text streams 422.

The user interface and settings module 460 may enable a user to specify intended operations that are performed by the other modules of the apparatus 400 and desired settings or parameters for those operations. For example, the user interface and settings module 460 may enable a user to specify the threshold values 414, initiate processing of a selected digital image by the various modules of the apparatus 400, and manually select the transcription 442 from a graphical depiction of the word lattice 432 that is generated in response to initiating processing of the selected digital image.

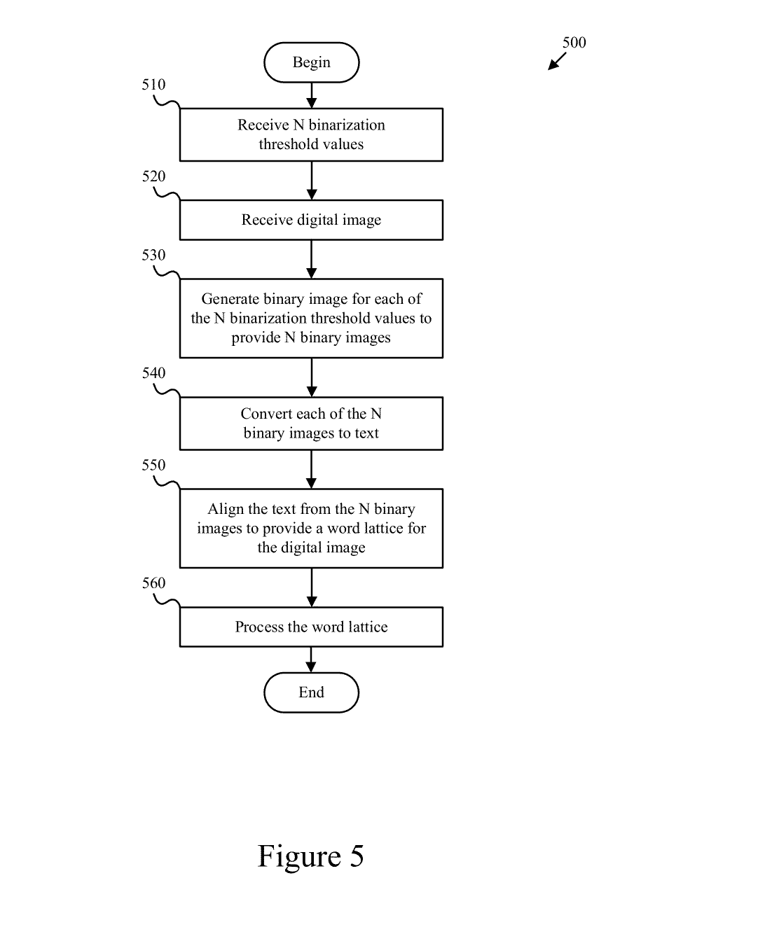

FIG. 5 is a flowchart diagram of a word recognition method 500 that leverages multiple-threshold-level binarization. As depicted, the method 500 may include receiving (510) a set of N threshold values, receiving (520) a digital image, generating (530) N binary images using the N threshold values, converting (540) each of the N binary images to text, aligning (550) the text from the N binary images to provide a word lattice, and processing (560) the word lattice. The word recognition method 500 may be conducted by the word recognition apparatus 400 or the like.

Receiving (510) a set of N threshold values may include receiving N distinct values. The N distinct values may be provided by the user interface and settings module 460. Receiving (520) a digital image may include receiving a grayscale or color image that includes text. Generating (530) N binary images using the N threshold values may include using the N threshold values to conduct N binarization operations on the digital image.

Converting (540) each of the N binary images to text may include using an OCR engine such as the OCR module 420 to convert each binary image to text. Aligning (550) the text from the N binary images to provide a word lattice may include inserting gaps within the text of each binary image in order to maximize the number of aligned characters. Alignment may be conducted progressively, approximately, or optimally. In some embodiments, each character in the word lattice is provided with a weight or score that indicates the likelihood that the character is accurate. For example, a character may be weighted according to the number of text streams that have a common character. For more information on aligning multiple OCR text streams see “Progressive alignment and discriminative error correction for multiple OCR engines” by W. B. Lund, D. D. Walker, and E. K. Ringger in Proceedings of the 11th International Conference on Document Analysis and Recognition (ICDAR 2011), Beijing, China, September 2011, which is incorporated herein by reference and “Improving optical character recognition through efficient multiple system alignment,” by W. B. Lund and E. K. Ringger in Proceedings of the 9th ACM/IEEE-CS joint conference on Digital libraries, 231-240, ACM, Austin, Tex., USA (2009) which is also incorporated herein by reference.

Processing (560) the word lattice may include selecting a most likely word sequence (i.e., transcription) or command sequence from the word lattice. In one embodiment, the word of greatest occurrence at each horizontal position in the lattice is used to select words. Word selection may be conducted using a selection model and/or a vocabulary.

FIG. 6 is an example digital image 610 containing text 620 and a corresponding word lattice 630 generated therefrom using one embodiment of the method of FIG. 4. Word hypotheses are separated by the vertical bar symbol ‘|’ within the lattice and correct word hypotheses are highlighted in bold characters. In the depicted embodiment, the word lattice 630 comprises parallel text streams 632a through 632e corresponding to distinct threshold values 634a through 634e. The text streams 632 are sorted in priority from the lowest error rate for a training corpus to the highest error rate as they would be for progressive alignment. The text streams 632 are aligned to maximize the occurrence of matched characters at the various horizontal offsets in the lattice. The “dash” character 640 represents an inserted gap within a text stream 632 that facilitates alignment.

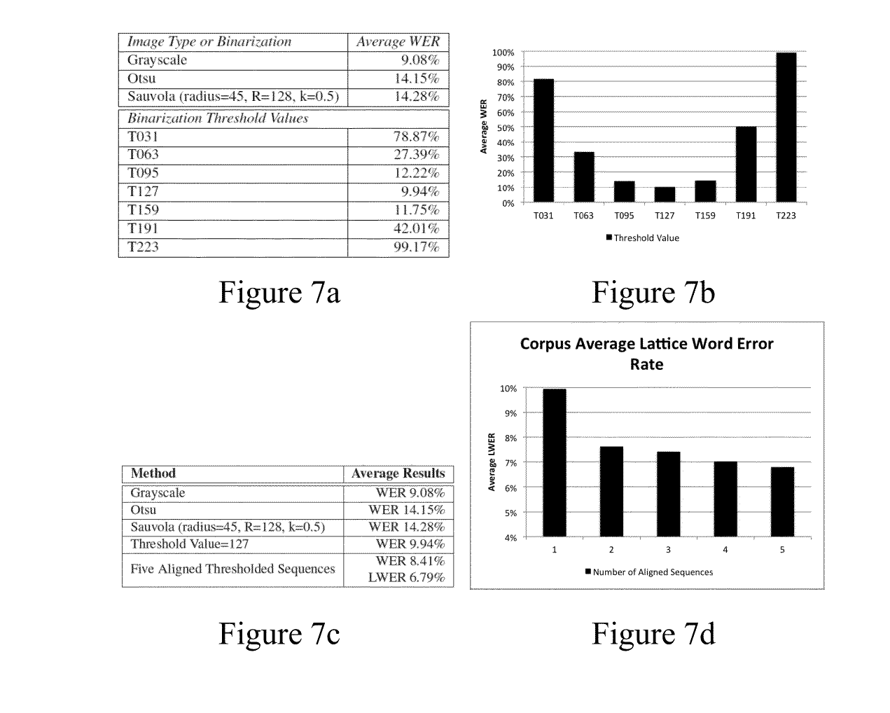

FIGS. 7a and 7c are tables and FIGS. 7b and 7d are graphs comparing word error rates for optical character recognition using grayscale images for a specific corpus along with various forms of binarization on the grayscale images. The specific corpus used was a collection of 1,074 images from the 19th Century Mormon Article Newspaper (19thCMNA) index. The OCR engine used for comparison purposes was Abbyy FineReader version 10.0 which is currently the best commercially available recognizer for the corpus (and many other corpora). For the specified corpus, Abbyy FineReader version 10.0 achieved a baseline grayscale word error rate of 0.0908 or 09.08 percent. For the depicted corpus and OCR engine, threshold adaptation methods such as the Otsu and Sauvola methods resulted in a higher word error rate than the baseline grayscale word error rate. As shown in FIG. 7a, the best binaraization threshold (i.e., 127) achieved a word error rate of 0.0994 or 09.94 percent.

By using the methods disclosed herein, transcription word errors rates of 0.0841 (8.41 percent) and lattice word error rates of 0.0679 (6.79 percent) were achieved for the specified corpus. The lattice word error rate (LWER) represents a lower bound on the word error rate that can be achieved for a transcription of the specified corpus if one had perfect knowledge on how to select the correct word from the lattice. Given the gap between the transcription word error rate and the lattice word error rate, one of skill in the art will appreciate that additional improvement may be achievable for the methods disclosed herein by improving the word selection process within the word lattice.

The demonstrated reduction of word error rate from 0.0908 for grayscale images to 0.0841 for multiple-threshold-level binarization represents a 7.4 percent improvement in the word error rate for the corpus and OCR engine mentioned above. In the experience of the Applicants, the magnitude and cause of those improvements is significant and unexpected—particularly to those of skill in the art of OCR processing of historical documents. For more information on the benefits and theory behind the means and methods disclosed herein see “Why multiple document image binarizations improve OCR,” by Lund, W. B., Kennard, D. J., and Ringger, E. K., in [Proceedings of the Workshop on Historical Document Imaging and Processing 2013 (HIP 2013)], which is incorporated herein by reference.

It should be noted that the claimed invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for converting digital images to words, the method comprising:
receiving a digital image comprising text;
generating a binary image from the digital image for each of N binarization threshold values to provide N binary images, where N is greater than or equal to 2;
converting each of the N binary images to text; and
aligning the text from the N binary images to provide a word lattice for the digital image.

2. The method of claim 1, wherein aligning the text comprises prioritizing the text from the N binary images according to error rates on a training set.

3. The method of claim 1, wherein the training set is a synthetic training set.

4. The method of claim 1, further comprising inserting gaps within the text of a higher priority binary image to facilitate alignment.

5. The method of claim 1, wherein the N binarization threshold values are equally spaced.

6. The method of claim 1, further comprising selecting a word transcription from among alternative transcription hypotheses encoded in the word lattice using a selection model.

7. The method of claim 1, wherein the selection model leverages a textual context.

8. The method of claim 1, further comprising enabling a user to select a word sequence from the word lattice to provide a selected word sequence.

9. The method of claim 1, further comprising initiating an action corresponding to text within the word lattice.

10. An apparatus for converting digital images to words, the apparatus comprising:
a processor for executing one or more modules;
a binarization module configured to receive a digital image comprising text and generate a binary image from the digital image for each of N binarization threshold values to provide N binary images, where N is greater than or equal to 2;
an OCR module configured to convert each of the N binary images to text; and
an alignment module configured to align the text from the N binary images to provide a word lattice for the digital image.

11. The apparatus of claim 10, wherein the alignment module prioritizes text from the N binary images according to error rates on a training set.

12. The method of claim 11, wherein the training set is a synthetic training set.

13. The apparatus of claim 10, wherein the alignment module is further configured to insert gaps within the text of a higher priority binary image to facilitate alignment.

14. The apparatus of claim 10, wherein the N binarization threshold values are equally spaced.

15. The apparatus of claim 10, further comprising a transcription module configured to select a word transcription from among alternative transcription hypotheses encoded in the word lattice using a selection model.

16. The apparatus of claim 10, wherein the selection model leverages a textual context.

17. The apparatus of claim 10, further comprising a user interface module configured to enable a user to select a word sequence from the word lattice to provide a selected word sequence.

18. The apparatus of claim 10, further comprising a command module configured to initiate an action corresponding to text within the word lattice.

19. A computer readable medium comprising executable instructions for converting digital images to words, wherein the executable instructions comprise the operations of:
receiving a digital image comprising text;
generating a binary image from the digital image for each of N binarization threshold values to provide N binary images, where N is greater than or equal to 2;
converting each of the N binary images to text; and
aligning the text from the N binary images to provide a word lattice for the digital image.

20. The computer readable medium of claim 19, wherein the instructions further comprise the operation of selecting a word transcription from among alternative transcription hypotheses encoded in the word lattice.
